(19) United States
(12) Patent Application Publication
(10) Pub. No.: US 2017/0371437 A1
(43) Pub. Date: Dec. 28, 2017

(54) STYLUS

(71) Applicant: Sunrex Technology Corp., Taichung City (TW)

(72) Inventors: Shun-Pin Lin, New Taipei City (TW); Jyun-Ying Jin, New Taipei City (TW)

(73) Assignee: Sunrex Technology Corp.

(21) Appl. No.: 15/277,993

(22) Filed: Sep. 27, 2016

(30) Foreign Application Priority Data
Jun. 24, 2016 (TW) 105209510

(51) Int. Cl. G06F 3/0354; G06F 3/044; G06F 3/038

(52) U.S. Cl. CPC G06F 3/03545; G06F 3/0383; G06F 3/044

(57) ABSTRACT

A stylus for a capacitive touch sensor device includes a tip unit, a signal amplification unit and a body unit. The tip unit generates a sensing signal under influence of an electric field. The signal amplification unit is electrically connected to the tip unit and generates an amplified signal by amplifying the sensing signal. The body unit includes a feedback component electrically connected to the signal amplification unit, and an insulation component disposed between the feedback component and the tip unit. The feedback component is made of conducting material and disposed adjacent to the tip unit, so that an electric field resulting from the amplified signal received by the feedback component is fed back to the tip unit.

### CROSS-REFERENCE TO RELATED APPLICATION

This application claims priority of Taiwanese Patent Application No. 105209510, filed on Jun. 24, 2016.

### FIELD

The disclosure relates to a stylus, and more particularly to a stylus for a capacitive touch sensor device.

### BACKGROUND

A conventional capacitive stylus is designed to alleviate user's discomfort resulting from long-term operation of a touchscreen by his/her finger, and is utilized in a condition that precise operation of the touchscreen is required. The size of a tip of the conventional capacitive stylus should be large enough (i.e., outside diameter>5 mm) so that a capacitance formed between the conventional capacitive stylus and the touchscreen is sufficient for being sensed by the touchscreen. However, the large size of the tip may hinder sight of the user, resulting in operational inconvenience.

To mitigate the above-mentioned issue, conventional active capacitive styluses are available on the market. However, a first type of conventional active capacitive stylus is workable only when used in combination with a specific type of touchscreen and a specific type of control chip, and is not compatible with general touchscreen products on the market. For a second type of conventional active capacitive stylus, while not limited to being only compatible with a specific type of touchscreen, it may have an issue of unstable operation owing to feedback oscillation, which is caused by interference resulting from mutual inductance of two nearby coils having identical operational frequencies and used for communication and synchronization.

### SUMMARY

Therefore, an object of the disclosure is to provide a stylus for a capacitive touch sensor device that can alleviate at least one of the drawbacks of the prior art.

The stylus includes a tip unit, a signal amplification unit and a body unit.

The tip unit is configured to generate, when the tip unit is near the capacitive touch sensor device, a sensing signal under influence of an electric field created by the capacitive touch sensor device.

The signal amplification unit is electrically connected to the tip unit, and is configured to receive the sensing signal and to generate an amplified signal by amplifying the sensing signal.

The body unit includes a feedback component and an insulation component. The feedback component is electrically connected to the signal amplification unit, and is configured to receive the amplified signal. The insulation component is disposed between the feedback component and the tip unit, and is configured to electrically insulate the feedback component from the tip unit.

The feedback component is made of conducting material and is disposed adjacent to the tip unit, so that an electric field resulting from the amplified signal received by the feedback component is fed back to the tip unit.

### BRIEF DESCRIPTION OF THE DRAWINGS

Other features and advantages of the disclosure will become apparent in the following detailed description of the embodiment with reference to the accompanying drawings, of which:

FIG. 1 is a sectional schematic view illustrating an embodiment of a stylus according to the disclosure;

FIG. 2 is a block diagram illustrating the embodiment of the stylus according to the disclosure;

FIG. 3 is a schematic diagram illustrating electric filed lines of an electric field of a touchscreen when an embodiment of the stylus according to the disclosure is disposed adjacent to the touchscreen;

FIG. 4 is a circuit diagram illustrating one embodiment of a signal amplification unit of the stylus according to the disclosure;

FIG. 5 is a schematic diagram illustrating the electric field of the touchscreen; and

FIG. 6 is a schematic diagram illustrating the electric field of the touchscreen when the user is touching the touchscreen with his/her finger.

### DETAILED DESCRIPTION

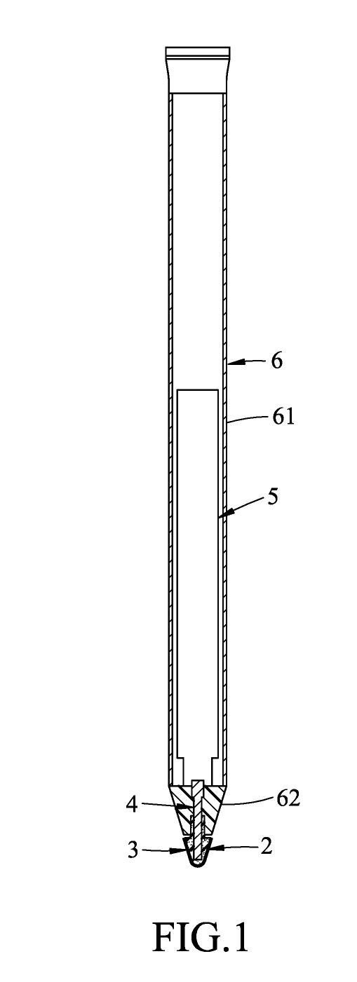

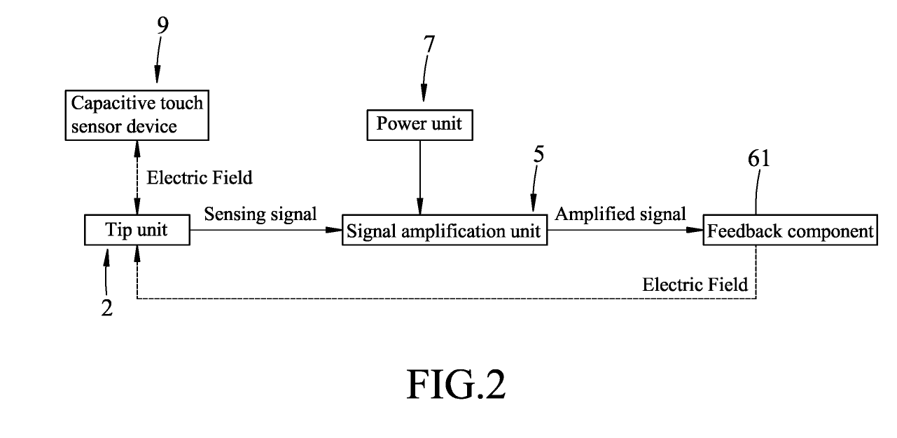

Referring to FIGS. 1 to 3, an embodiment of a stylus for a capacitive touch sensor device 9 according to the disclosure is illustrated. The capacitive touch sensor device 9 is a projected-capacitive touchscreen in this embodiment. However, the capacitive touch sensor device 9 is not limited to a touchscreen, and may be exemplified as a capacitive sensing touchpad in other embodiments. The stylus includes a tip unit 2, a protective layer 3, a conductive connecting unit 4, a signal amplification unit 5, a body unit 6 and a power unit 7.

The tip unit 2 is configured to generate, when the tip unit 2 is placed near the capacitive touch sensor device 9, a sensing signal under influence of an electric field created by the capacitive touch sensor device 9. Meanwhile, a stylus capacitance 21 is formed between the tip unit 2 and the capacitive touch sensor device 9.

To achieve better capacitive effect, a value of surface impedance of the tip unit 2 is between, but is not limited to, one kilo-ohm and one mega-ohm, which may be implemented by utilizing known materials to make the tip unit 2, so that the surface impedance is not too low to induce sufficient stylus capacitance, and is not too high to generate the sensing signal under the influence of the electric field created by the capacitive touch sensor device 9.

In addition, the tip unit 2 is made of a material having at least one of resilience or abrasion resistance. Hardness of the tip unit 2 is greater than or equal to, but is not limited to, the 2H grade of pencil hardness for better scratch resistance. The pencil hardness herein refers to hardness determined according to Standard Test Method for Film Hardness by Pencil Test.

When made of conductive polyformaldehyde (POM), the tip unit 2 has appropriate surface impedance and features of resilience, abrasion resistance and scratch resistance.

The protective layer 3 covers a portion of the tip unit 2 that would otherwise be in contact with the capacitive touch sensor device 9, so as to prevent the tip unit 2 from abrasion. In one implementation, the protective layer 3 is made of a material having abrasion resistance, and is formed by spraying the material to the portion of the tip unit 2. The material for the protective layer 3 is for example polyurethane (PU, or called PUR).

The conductive connecting unit 4 is rod-shaped, and is electrically connected between the tip unit 2 and the signal amplification unit 5 for transmission of the sensing signal. In addition, the conductive connecting unit 4 supports the tip unit 2 as well. The conductive connecting unit 4 is implemented by metal for better conductivity, but is not limited to being implemented by metal as long as conductivity and robustness are considered.

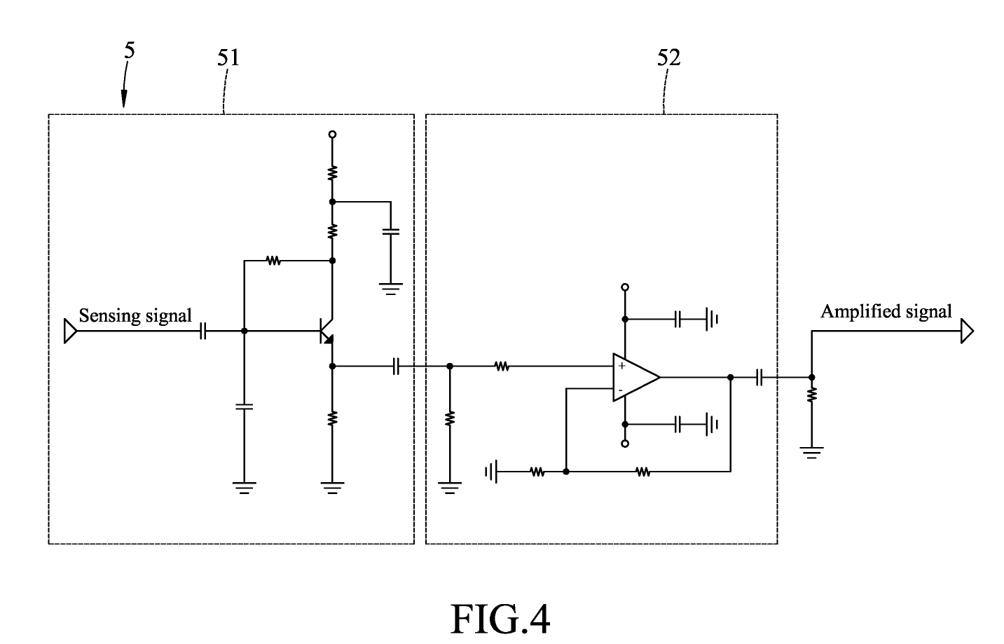

Referring to FIGS. 1, 2 and 4, the signal amplification unit 5 is electrically connected to the tip unit 2 via the conductive connecting unit 4, and is configured to receive the sensing signal and to generate an amplified signal by amplifying the sensing signal. The sensing signal received by the signal amplification unit 5 and the amplified signal generated by the signal amplification unit 5 are in phase.

The signal amplification unit 5 includes a buffer circuit 51 electrically connected to the tip unit 2, and an amplifier circuit 52 electrically connected to the buffer circuit 51.

The buffer circuit 51 is configured to receive the sensing signal from the tip unit 2 and to generate an internal signal based on the sensing signal. The buffer circuit 51 is exemplified as a voltage follower to provide a buffer for alleviating distortion of the sensing signal. It may be worth noting that gain of the buffer circuit 51 is, but is not limited to, about one.

The amplifier circuit 52 is configured to receive the internal signal from the buffer circuit 51 and to generate the amplified signal by amplifying the internal signal. The amplifier circuit 52 is exemplified as a non-inverting operational amplifier. Therefore, the amplified signal generated thereby and the sensing signal are in phase.

The body unit 6 is to be held by a user, and includes a feedback component 61 and an insulation component 62.

The feedback component 61 is configured to house the signal amplification unit 5, and is electrically connected to the amplifier circuit 52 of the signal amplification unit 5 for receiving the amplified signal. Moreover, the feedback component 61 is made of conducting material and is disposed adjacent to the tip unit 2, so that an electric field resulting from the amplified signal received by the feedback component 61 is fed back to the tip unit 2.

The insulation component 62 is disposed between the feedback component 61 and the tip unit 2, and is configured to electrically insulate the feedback component 61 from the tip unit 2.

For ease of use, the feedback component 61 is implemented to be barrel-shaped, and the insulation component 62, in combination with the tip unit 2, is implemented to be substantially cone-shaped.

Referring again to FIGS. 1 to 3, it is worth noting that, in this embodiment, the feedback component 61 is designed as a pen barrel to be held by a user's hand in use. Consequently, leakage current may be conducted from the feedback component 61 through the human body to ground when the stylus is in contact with or close to the capacitive touch sensor device 9. In other embodiments, the feedback component 61 may be implemented to be overlaid on a portion of the barrel-shaped body unit 6 as long as the feedback component 61 has a sufficiently large surface area to be in contact with the user's hand when the stylus is held by the user, and as long as the surface area of the feedback component 61 and a distance between the feedback component 61 and the tip unit 2 are able to result in sufficient electric field to be fed back to the tip unit 2.

The power unit 7 is electrically connected to the signal amplification unit 5 for supplying power thereto. The power unit 7 may be implemented by one or more batteries (not illustrated).

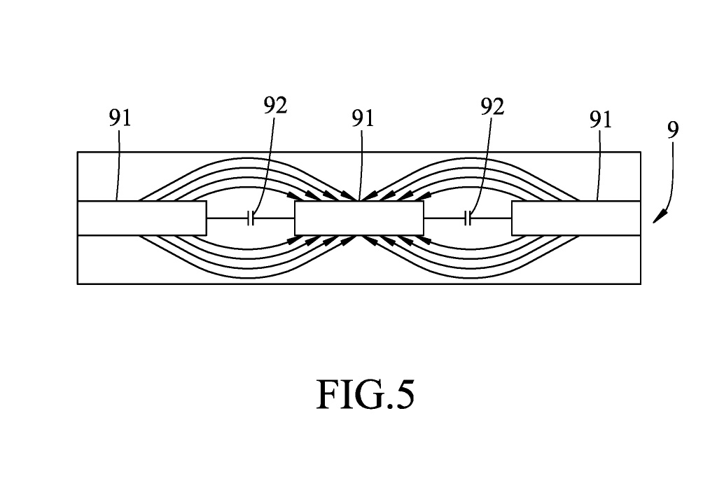

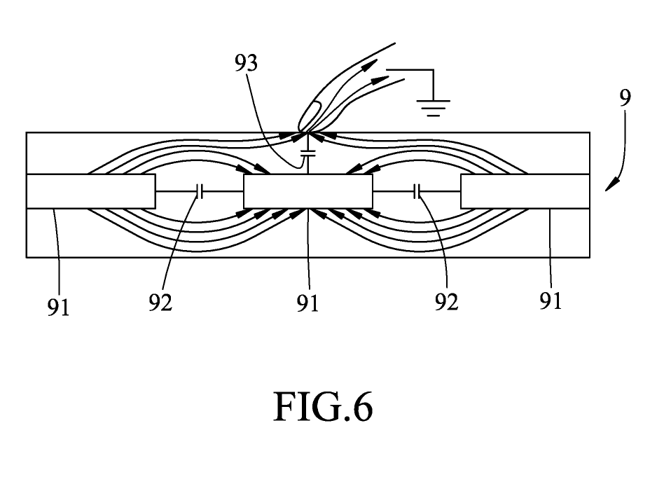

Principle of operation associated with the capacitive touch sensor device 9 is illustrated in FIGS. 5 and 6, and is described below. Since the capacitive touch sensor device 9, i.e., the projected-capacitive touchscreen in this embodiment, is readily known to one skilled in the art, details thereof will be omitted herein for the sake of brevity.

Referring to FIG. 5, the capacitive touch sensor device 9 includes a plurality of sensor traces 91, and a trace capacitance 92 is formed between any adjacent two of the sensor traces 91. When nothing capacitive is in contact with or nearby the capacitive touch sensor device 9, the electric field, which results from electric potential difference, is represented by electric field lines directed to at least one of the sensor traces 91 having lower potential. It should be noted that directions of the electric field lines are not limited to that depicted in the drawings, and may be altered based on different designs.

Referring to FIG. 6, since a human body is conductive, when a user's finger is in contact with the capacitive touch sensor device 9, the electric field is conducted to ground through a capacitive path 93 formed between the user's finger and the capacitive touch sensor device 9. In consequence, the electric field created by the capacitive touch sensor device 9 is changed and so do capacitances sensed by the sensor traces 91. In this way, touch sensing may be implemented.

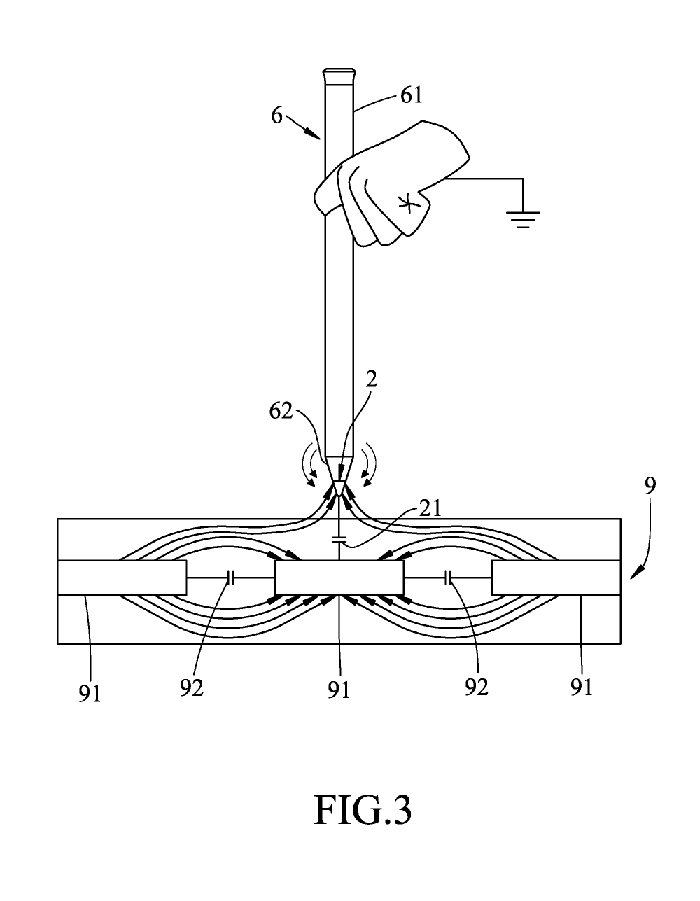

Referring to FIGS. 1 and 3, when approaching the capacitive touch sensor device 9, the tip unit 2 senses the electric field created by the capacitive touch sensor device 9 in such a manner that a portion of the electric field lines are directed to the tip unit 2, and generates the sensing signal according to the electric field thus sensed. The sensing signal is outputted by the tip unit 2 to the signal amplification unit 5. The signal amplification unit 5 amplifies the sensing signal and outputs accordingly the amplified signal to the feedback component 61. Because the feedback component 61 is disposed adjacent to the tip unit 2, the electric field resulting from the amplified signal received by the feedback component 61 is fed back to the tip unit 2. Moreover, since the sensing signal and the amplified signal are in phase, positive feedback occurs and enhances influence of the tip unit 2 on the electric field created by the capacitive touch sensor device 9. Therefore, capacitances sensed by the sensor traces 91 are increased. In other words, even though a size of the tip unit 2 is small (e.g., outside diameter<2 mm), the signal amplification unit 5 and the feedback component 61 can still induce sufficiently large capacitance for a corresponding one of the sensor traces 91 to sense, so as to maintain a favorable touch sensing effect.

Furthermore, by contact between the user and the feedback component 61, the leakage current is conducted to ground through a conductive path (i.e., the human body) therebetween. As a result, most noise such as background signal noise can be absorbed by the human body. When the background signal noise is relatively large, interference resulting from the noise is reduced due to absorption of the noise by contact between the stylus and the human body, and hence a better touch control is achieved. When the noise is insignificant or does not exist, the stylus of this disclosure can function as well without direct contact with the human body (e.g., when held by a user who wears gloves).

To sum up, the stylus according to the disclosure has the following advantages.

First of all, by the signal amplification unit 5 and the feedback component 61, the sensing signal generated by the tip unit 2 is amplified, and the electric field resulting from the amplified signal is fed back through the feedback component 61 to the tip unit 2. Therefore, influence of the tip unit 2 on the electric field created by the capacitive touch sensor device 9 is enhanced, and the capacitance sensed by adjacent sensor traces 91 is consequently increased. In this way, the tip unit 2 can be designed with a small size while maintaining a favorable touch sensing effect, so precise operation using the stylus equipped with a small tip unit 2 is possible. Moreover, the stylus of this disclosure is not limited to being used in cooperation with a specific type of capacitive touch sensor device 9, so high compatibility is achieved.

Second, the tip unit 2 is made of a known material (e.g., POM) to have the surface impedance ranging between one kilo-ohm and one mega-ohm, so a favorable capacitive effect between the tip unit 2 and the capacitive touch sensor device 9 is achieved.

Third, by selecting a material which has at least one of resilience or abrasion resistance to implement the tip unit 2, or by using the protective layer 3 which is made of an appropriate material to cover the portion of the tip unit 2 that would otherwise be in contact with the capacitive touch sensor device 9, the tip unit 2 may serve as a cushion to improve comfort when the stylus is used for writing. In addition, durability of the stylus is promoted so as to increase a service life of the stylus.

Finally, by tuning the distance between the tip unit 2 and the feedback component 61 with various sizes of the insulation component 62, an appropriate gain of the positive feedback from the feedback component 61 to the tip unit 2 can be achieved even with a reduced gain of the signal amplification unit 5. Thus, power is efficiently utilized to achieve a power saving effect. Furthermore, by tuning the gain of the amplifier circuit 52 so as to adjust the gain of the positive feedback from the signal amplification unit 5 through the feedback component 61 to the tip unit 2, an issue of oscillation caused by positive feedback in a conventional stylus can consequently be alleviated. Therefore, stability of the stylus of this disclosure is enhanced.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A stylus for a capacitive touch sensor device, said stylus comprising:
a tip unit configured to generate, when said tip unit is near the capacitive touch sensor device, a sensing signal under influence of an electric field created by the capacitive touch sensor device;
a signal amplification unit electrically connected to said tip unit, and configured to receive the sensing signal and to generate an amplified signal by amplifying the sensing signal; and
a body unit including
a feedback component electrically connected to said signal amplification unit, and configured to receive the amplified signal, and
an insulation component disposed between said feedback component and said tip unit, and configured to electrically insulate said feedback component from said tip unit;
wherein said feedback component is made of conducting material and is disposed adjacent to said tip unit, so that an electric field resulting from the amplified signal received by said feedback component is fed back to said tip unit.

2. The stylus as claimed in claim 1, wherein a value of surface impedance of said tip unit is between one kilo-ohm and one mega-ohm.

3. The stylus as claimed in claim 1, wherein said tip unit is made of a material having at least one of resilience or abrasion resistance.

4. The stylus as claimed in claim 1, wherein hardness of said tip unit is greater than or equal to the 2H grade of pencil hardness.

5. The stylus as claimed in claim 1, wherein said tip unit is made of conductive polyformaldehyde.

6. The stylus as claimed in claim 1, further comprising a protective layer which covers a portion of said tip unit that would otherwise be in contact with the capacitive touch sensor device.

7. The stylus as claimed in claim 6, wherein said protective layer is made of polyurethane.

8. The stylus as claimed in claim 6, wherein said protective layer is made of a material having abrasion resistance, and is formed by spraying the material to said tip unit.

9. The stylus as claimed in claim 1, further comprising a conductive connecting unit which is electrically connected between said tip unit and said signal amplification unit for transmission of the sensing signal.

10. The stylus as claimed in claim 1, wherein the sensing signal received by said signal amplification unit and the amplified signal generated by said signal amplification unit are in phase.

11. The stylus as claimed in claim 1, wherein:
said signal amplification unit includes
a buffer circuit electrically connected to said tip unit, and
an amplifier circuit electrically connected to said buffer circuit and said feedback component of said body unit;
said buffer circuit is configured to receive the sensing signal from said tip unit and to generate an internal signal based on the sensing signal; and
said amplifier circuit is configured to receive the internal signal from said buffer circuit and to generate the amplified signal by amplifying the internal signal.

12. The stylus as claimed in claim 11, wherein said buffer circuit is implemented by a voltage follower.

13. The stylus as claimed in claim 11, wherein said amplifier circuit is implemented by a non-inverting operational amplifier.
